(19) United States
(12) Patent Application Publication
(10) Pub. No.: US 2019/0271861 A1
(43) Pub. Date: Sep. 5, 2019

(54) BLOOD TRAILING EYEWEAR

(71) Applicant: Hose, LLC, Huntsville, AL (US)

(72) Inventor: Mark D. Hose, Huntsville, AL (US)

(73) Assignee: Hose, LLC, Huntsville, AL (US)

(21) Appl. No.: 16/290,932

(22) Filed: Mar. 3, 2019

Related U.S. Application Data
(60) Provisional application No. 62/638,079, filed on Mar. 3, 2018.

(51) Int. Cl. G02C 7/10

(52) U.S. Cl. CPC G02C 7/107; G02C 7/104

(57) ABSTRACT

A blood-trailing eyewear apparatus fashioned as a pair of glasses; providing contrast enhancements to help hunters with game recovery by enhancing red colors.

### CROSS-REFERENCE TO RELATED APPLICATION

The present application claims priority to U.S. Provisional Patent Application Ser. No. 62/638,079 filed Mar. 3, 2018 and entitled Blood Trailing Eyewear, which is incorporated by reference as if fully set forth herein.

### FIELD OF THE DISCLOSURE

The apparatus set forth herein relates generally to specialty eyewear (e.g. glasses) possessing certain properties that enhance the contrast of blood-red colors. This is particularly beneficial to hunters when trailing blood.

### BACKGROUND

Hunters spend considerable time recovering game that have been shot. When the game runs away their blood-trails can become increasingly faint to non-existent. During daytime recovery the blood-trail is observed in the presence of natural sunlight. During nighttime recovery the blood-trail is illuminated with an artificial light source (e.g. flashlight or lantern).

### SUMMARY

Contrast enhancing glasses of the present disclosure help hunters recovery game in both daytime and nighttime scenarios. These glasses improve the color contrast of blood-red colors.

The glasses of the present disclosure use special light absorbing materials in the creation of the lenses. These lenses make blood-red colors appear more intense by selectively filtering competing colors. The methods describe herein for improving the color contrast of blood-red colors are considered unique. Prior art descriptions for performance sunglasses rely on notching portions of the visible light spectrum with the intent of enhancing the view while preserving the majority of all the visible colors in the view. However, the methods described herein filter the visible light with the purpose of dulling all colors except for blood-red colors. It is this effect that makes the blood-red colors appear to be more intense in the presence of the other dulled colors.

The methods described herein involve the attenuation of select portions of the visible spectrum so that the resultant filtered spectrum mimics the spectrum of actual blood. So, when blood-red colors are viewed thru the filtered lenses, these colors effectively pass thru the filter with little to no attenuation. However, all other colors are attenuated in a particular fashion so that they appear dull when viewed thru the filtered lenses. This produces an effect where the blood-red colors appear very bright in the presence of the other dull colors.

It will be understood that for the purposes of the above summary, certain aspects, advantages, and novel features are described. However, it is to be understood that not necessarily all such advantages may be achieved in accordance with any one particular embodiment. Thus, apparatuses or methods claimed may be embodied or carried out in a manner that achieves or optimizes one advantage or group of advantages as taught herein without necessarily achieving other advantages as may be taught or suggested herein.

### BRIEF DESCRIPTION OF THE DRAWINGS

The present disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views. The present disclosure contains at least one drawing executed in color. Copies of this patent or patent application publication with color drawing(s) will be provided by the Office upon request and payment of the necessary fee.

FIG. 1 is exemplary eyewear in accordance with an embodiment of the present disclosure.

FIG. 2 is a graph showing light spectrums for artificial (LEDs) and natural (sunlight) light sources.

FIG. 3 is the visible light spectrum.

FIG. 4 is a side view of the human eye detailing the rod and cone photoreceptors and a front view of the human eye detailing the rod and cone photoreceptors.

FIG. 5 is a graph illustrating the response curves for the three types of color photorecptors in the human eye.

FIG. 6 is a graph illustrating the photopic, scotopic, and mesopic responses of human vision.

FIG. 7 is a graph showing the spectral absorbance of blood.

FIG. 8 is a graph showing the spectral transmittance of blood.

FIG. 9 is a graph illustrating the attenuation of colors with wavelengths less than those of blood-red colors.

FIG. 10 is a graph illustrating a significant attenuation of red colors with wavelengths less than those of blood-red colors.

FIG. 11 is a graph illustrating a progressive attenuation of colors with wavelengths less than those of red colors.

FIG. 12 is a graph of the spectral transmittance for a wide-band absorber (Cinelux #16 Light Amber).

FIG. 13 is a graph of the spectral absorbance for a narrow-band absorber (Epolight 5822) with peak absorbance near 576 nm.

FIG. 14 is a graph of the spectral absorbance for a narrow-band absorber (Epolight 5838) with peak absorbance near 534 nm.

FIG. 15 is a graph of the spectral absorbance for a narrow-band absorber (Epolight 5843) with peak absorbance near 444 nm.

FIG. 16 is a graph of the transmission percentage of light of exemplary eyewear as depicted in FIG. 1.

### DETAILED DESCRIPTION

The present disclosure describes specialty contrast-enhancing eyewear (e.g. glasses) possessing properties that enhance the contrast of blood-red colors. This can be particularly helpful to hunters when trailing blood. The eyewear of the present disclosure is designed to improve color contrast and to enhance blood-red colors, which in turn helps hunters see the blood-trail better. The eyewear provides filtering of the visible light and has specific consideration given to the visual response of the human eye and also to the optical properties of blood.

In one embodiment, the spectral filtering of the eyewear is accomplished via the meticulous combination of light absorbing dyes (or pigments) and polycarbonate (plastic). This is referred to as color-compounding, and the resulting compound is used to form the lenses of the glasses. Combinations of narrow-band and wide-band absorbers allow the creation of custom spectrums for the filtered light. The various wavelengths of the filtered light can receive predictable attenuations across the spectrum. These attenuations can vary from slight to significant based on the dye selections and relative concentrations. There exists combinations of these dyes that allow the creation of a filtered spectrum that mimics the spectrum of blood. This filtered spectrum has similar shape, proportions, and wavelength transitions as that of blood.

In another embodiment, rare earth elements may also be mixed in with polycarbonate (or glass) as the lenses of the eyewear are being manufactured.

Custom interference filters may also be applied to the lenses externally via vapor deposition and active ion-sputtering. However, interference filters do not provide the same performance as color-compounding. The interference filters instead block bands of wavelengths producing a binary effect where the wavelengths are either fully passed or blocked, with no variations in the amplitude of the filtered light.

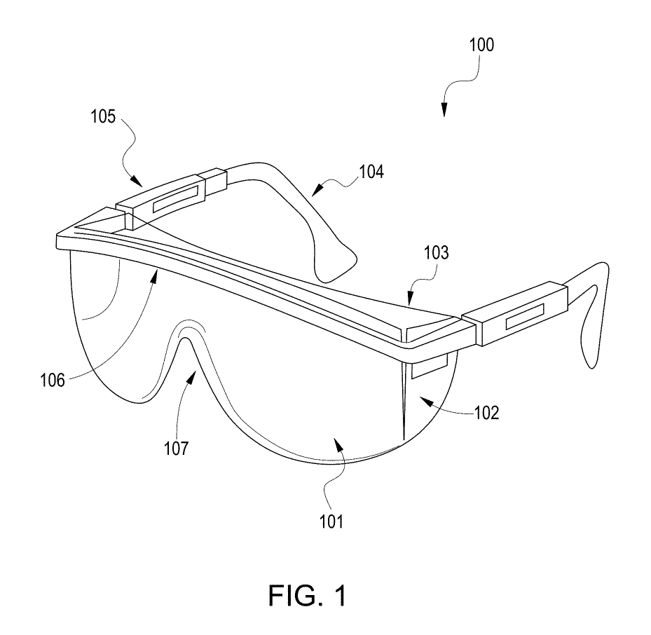

With reference first to FIG. 1, an exemplary blood-trailing eyewear apparatus 100 as illustrated comprises an impact resistant lens(es) 101 and side shield(s) 102 and a top shield 103. The side shield(s) 102 and top shield 103 help block light coming in from the sides and top; which helps to apply filtering to most all of the light coming to the wearers eyes. The side shield(s) 102 and top shield 103 can be constructed as solid plastic to block light entering from the top and sides; or opaque to reduce light entering from the top and sides; or made of the lens 101 filter material to selectively filter the light from the top and sides. The eyewear includes arms 104 with adjustments 105 and an optional frame 106 and a nose bridge 107. These are standard components of traditional safety glasses; but the lens(es) are specially designed to enhance blood-red colors; creating the blood-trailing eyewear apparatus.

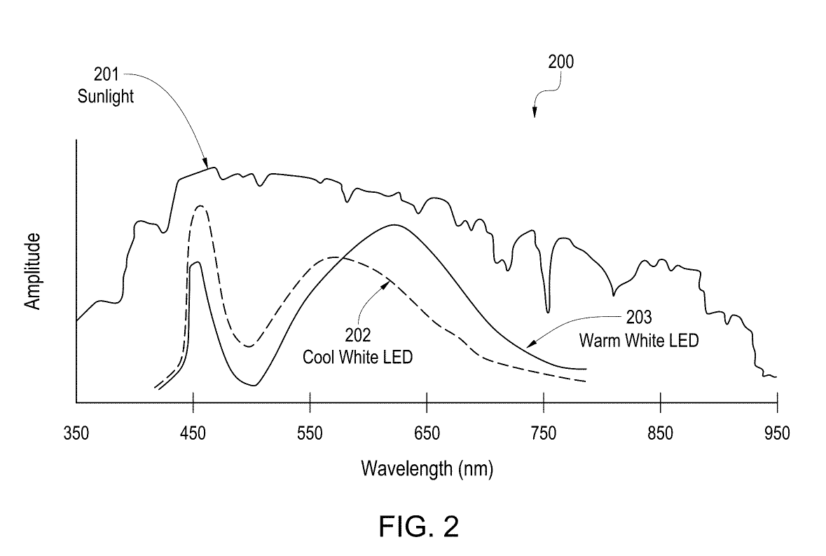

FIG. 2 compares the light spectrums for artificial light sources (cool white LEDs 202 and warm white LEDs 203) with natural light sources (sunlight 201). It is understood that natural sunlight is many times brighter than LEDs; so, the curves 200 were scaled for relative comparison of their spectral distributions. White LEDs have a dominant blue contributor in or around 450 nm (as illustrated in FIG. 2). White LEDs also have a somewhat gaussian distribution of intensity between 500 nm and 750 nm. Sunlight on the other hand has a smoother (somewhat flat) distribution between 450 nm and 750 nm. The contrast enhancing eyewear described herein uses natural sunlight 201 during daytime game recovery, and uses artificial (e.g. LED flashlight 202 and 203) light during nighttime recovery

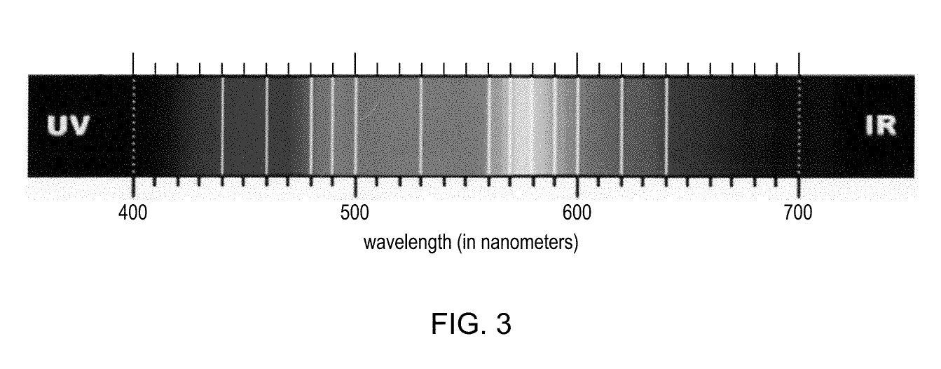

FIG. 3 shows the visible light spectrum. It is generally considered to span wavelengths between 360 nm and 830 nm for daylight levels of illumination. While the human eye is capable of seeing wavelengths across this entire range, under normal viewing conditions it is effectively limited to a range of 400 nm to 700 nm. Sunlight is distributed across the spectrum and can be decomposed into specific colors that result from the particular wavelengths of light. However, objects whether natural or man-made, are not resigned to a single specific wavelength or wavelength-color, but instead relate to combinations of wavelength colors. For example, an orange object does not consist of simply a 600 nm wavelength of light but instead consists of a group of wavelengths that may include a group of red wavelengths and a group of green wavelength (red and green are added to produce orange). Again, the point is that an object observed by a human does not consist of a single color wavelength but instead consists of groups of color wavelengths that are processed by the eye and brain (color perception).

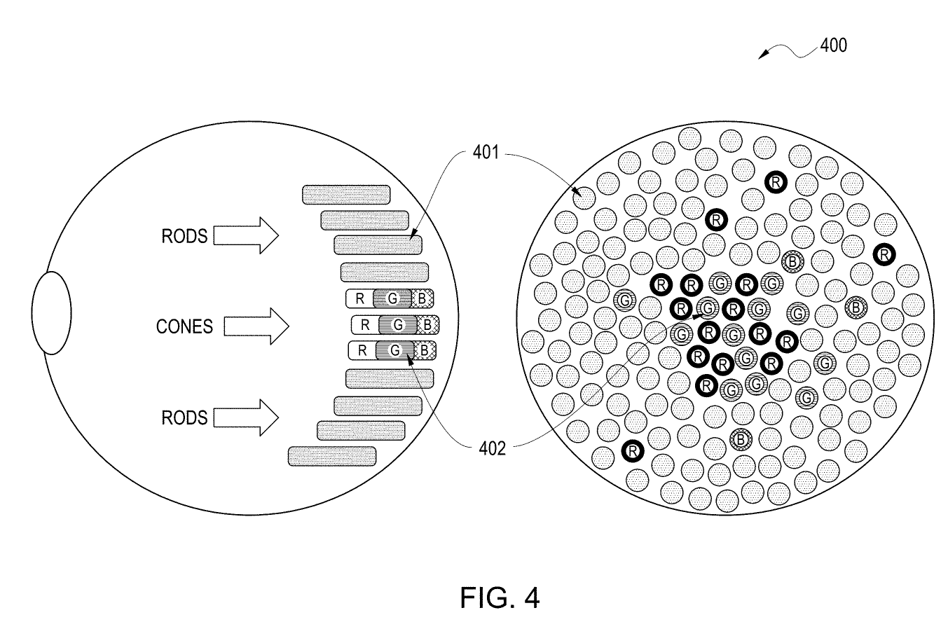

FIG. 4 illustrates certain physical aspects of the human eye. The eye has two primary types of light-sensing cells (known as photoreceptors) called rods 401 and cones 402. Their names refer to their actual geometric shapes. FIG. 4 illustrates the distribution of rods 401 and cones 402 in the human eye. Cones 402 are concentrated at the center with minimal distribution elsewhere. Rods 401 occupy the majority of the area except in the center. Rods are more numerous, some 120 million whereas cones are less numerous, some 6 to 7 million. Among the cones there are three types of color receptors. One type is sensitive to long wavelengths like reds. One type is sensitive to medium wavelengths like greens. One type is sensitive to short wavelengths like blues.

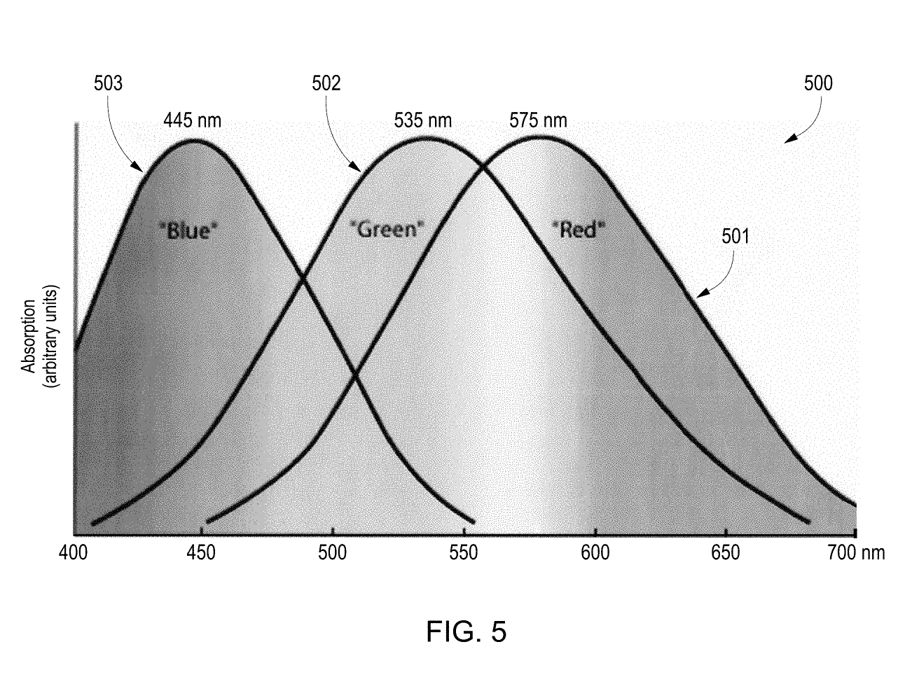

FIG. 5 illustrates the response of the three types of color photoreceptors (cones). Red-sensitive cones have a response curve 501 showing particularly sensitive to longer wavelengths with a peak sensitivity at or near 575 nm. Green-sensitive cones have a response curve 502 showing a particular sensitivity to medium wavelengths with a peak sensitivity at or near 535 nm. Blue-sensitive cones have a response curve 503 showing a particular sensitivity to short wavelengths with a peak sensitivity at or near 445 rm.

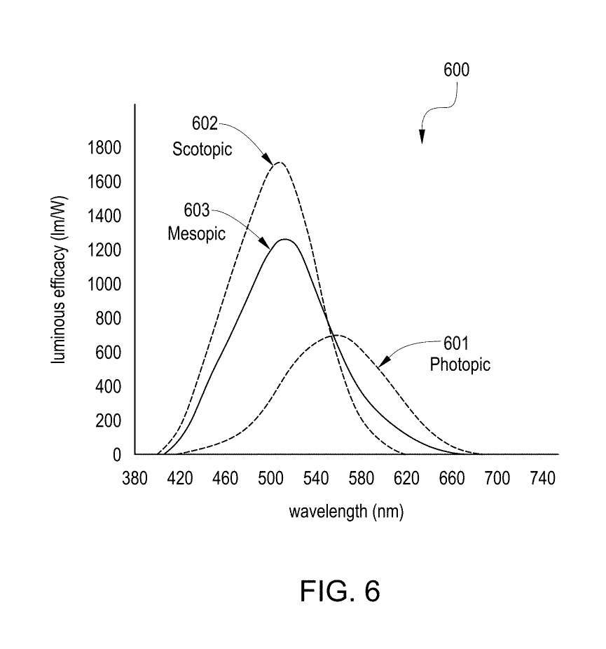

FIG. 6 illustrates the response of the human eye in dark, near-dark, and daylight environments. Cones process visual information with a photopic response 601 in bright light (daytime). Rods process visual information with a scotopic response 602 in dark lighting conditions (nighttime). Between photopic and scotopic light levels is a range called mesopic. Mesopic response 603 exists in moderately low (but not dark) lighting conditions where the effectiveness of the cones 402 (FIG. 4) is diminished; and rods 401 (FIG. 4) strongly affect color perception by mixing with or tinting the color of the still active cones 402. The take away from FIG. 6 is that human vision is vastly different in dark, near-dark, and daylight environments. However, the methods described herein for enhancing blood-red colors produce best results in well lighted conditions; and whether they are used with natural sunlight or used in conjunction with bright artificial lights, these filters are operating within the photopic response 601 of the eye.

The actual color of blood depends on several factors to include the oxygenation levels of the blood, the amount of time that the blood has existed outside of its host body, and environmental conditions (e.g. temperature and moisture).

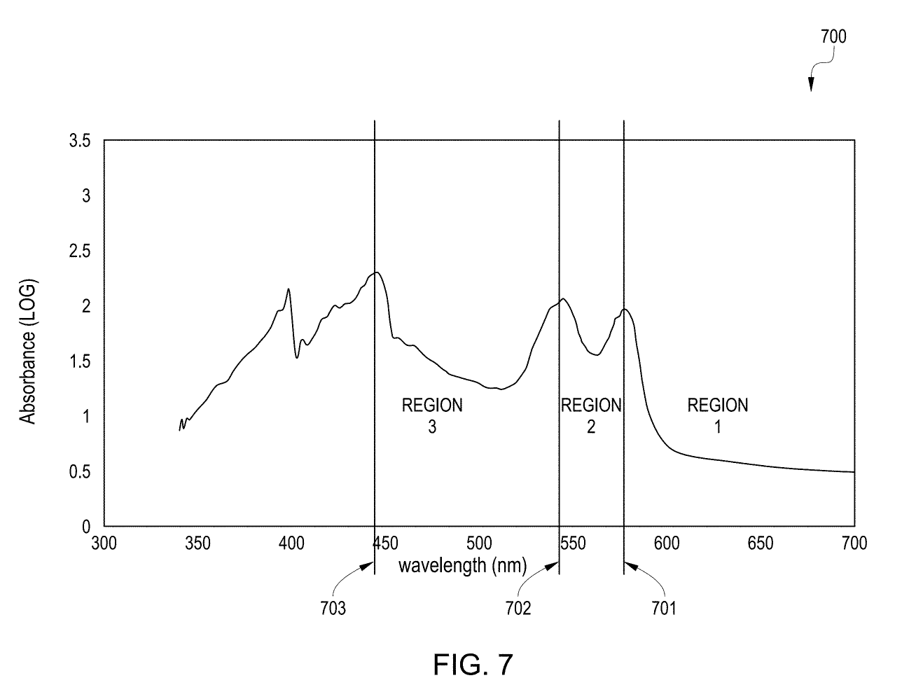

FIG. 7 shows an exemplary plot of the spectral absorbance of blood. The vertical peaks 701, 702, and 703 near 575 nm, 540 nm, and 440 nm, respectively, indicate areas in the spectrum where light wavelengths are predominately absorbed by the blood. It should be noted that this curve is plotted with a logarithmic scale, which enables us to see additional features that are not nearly as noticeable when plotted on a linear scale. FIG. 7 details three distinct regions (Region-1, Region-2, Region-3) that are separated by the absorption peaks (701, 702, 703). Wavelengths in Region-1 receive the least amount of absorption as compared to the amounts of absorption in Region-2 and Region-3. This relates to more of these wavelengths getting sent to the eye. Region-2 and Region-3 have noticeable features (valleys) that relate to local minima for absorption. The wavelengths in Region-2 are predominately green while the wavelengths in Region-3 are predominately blue with some green (blue-green). The relative proportions of the absorption in Region-1, Region-2, and Region-3 are significant as they define the optical properties of blood.

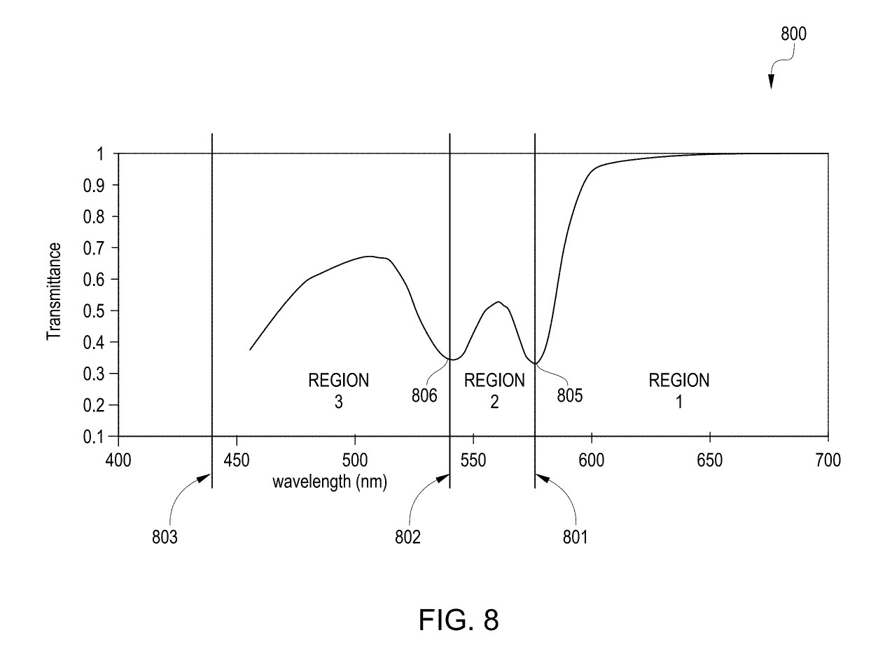

FIG. 8 shows an exemplary plot of the spectral transmittance of blood. This figure details three distinct regions (Region-1, Region-2, Region-3) separated by 801, 802, 803, corresponding to wavelengths near 575 nm, 540 nm, and 440 nm respectively. Region-1 contains wavelengths that are predominately red, and the transmittance for these wavelengths is significantly higher than those of the wavelengths in the other two regions. Region-3 contains wavelengths that are predominately blue with some green and the peak amplitude of the hump in this region is significantly less than the peak amplitude of Region-1, Region-2 contains wavelengths that are predominately green and the peak amplitude of the hump in this region is less than the peak amplitude of Region-3.

The relative proportions of the peak amplitudes of Region-1, Region-2, and Region-3 of FIG. 8 are carried forward in the creation of the filtered lenses. Narrow-band absorbers located at wavelengths between the three regions and one to the left of Region-3 can be integrated with the lens(es) to filter light and produce a filtered transmittance that mimics that of blood. That is to say that the resulting transmittance of the filter will resemble the transmittance of blood.

A narrow-band absorber can be added between the red and green regions 801 near 575 nm; absorbing light and producing a local minma 805. Another narrow-band absorber can be added between the green and blue regions 802 near 540 nm; absorbing light and producing a local minima 806. Another narrow-band absorber can be added near 440 nm 803. The importance of the absorbers being narrow-band is that they are sufficiently narrow so that their attenuation does not extend into the red region; because we want the red region to receive as little attenuation as possible.

The apparatus for the invention described herein is a filter that is in some cases worn by a human (glasses); and is specifically designed to promote (enhance) blood-red colors. This promotion (enhancement) of blood-red colors can also be accomplished using a combination of three methods: 1) attenuating all color wavelengths below red wavelengths of blood-red colors 2) significantly attenuating red color wavelengths below those of the red color wavelengths associated with blood-red colors (eliminating nearby red color wavelengths that are not blood-red colors); and 3) progressively attenuating other specific non red color wavelengths with emphasis put on the relative attenuations across the progression. The order of these three methods is not important but the composite effect of the three is important. Further, each method may also be used alone without use of the other two methods. The relative amplitudes resulting from the attenuations are important as they determine the relative amounts sunlight that passes (or gets blocked) for the wavelengths corresponding to the various colors (blue, green, yellow, orange, non-blood red, blood red). Passing too much red wavelength light in proportion to the other wavelength colors can create a red hue to other non red objects; obfuscating the desired contrast enhancements for red colors.

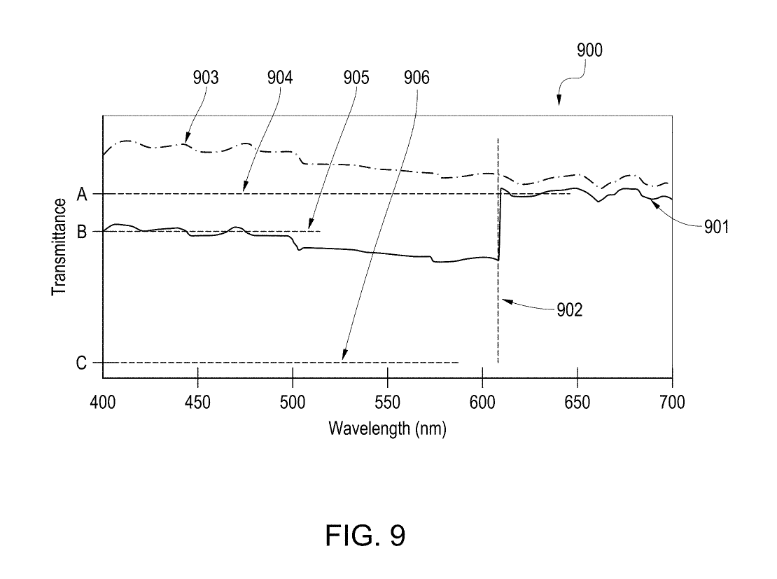

FIGS. 9-11 show how these three methods of attenuation are applied to sunlight 903 to produce an optimal filter that promotes blood-red colors. FIG. 9 illustrates the first method whereby sunlight 903 is attenuated for all visible wavelengths below those of the red wavelengths associated with blood-red colors. Blood-red wavelengths are between 610 nm and 750 nm. Attenuation in this area 901 is to be minimal as to keep the percentage transmittance high (e.g. above 80 percent). The actual color of the blood depends on several factors to include the oxygenation level of the blood, the amount of time the blood has existed outside of its host body, and environmental conditions (e.g. temperature and moisture). A transition wavelength 902 (which is herein synonymous with critical wavelength) represents a wavelength at which the attenuation of the filter goes from its maximum attenuation 906 denoted with dotted-line “C”; to its minimum attenuation 904 denoted with dotted-line “A”. The maximum attenuation occurs in the region of red colors with wavelengths below those of wavelengths associated with blood-red colors. The minimum attenuation starts in the region 901 containing red wavelengths that are associated with blood-red colors. The transition wavelength is typically in the range of about 580 nm to about 620 nm; particularly in the range of about 610 nm to about 618 nm; and more particularly about 614 nm. Attenuation is illustrated in these figures as decreases in transmittance; which has a relationship to absorption. The attenuation illustrated in FIG. 9 shows that the original sunlight spectrum 903 receives minimal attenuation for colors with wavelengths above the transition wavelength. The attenuation resulting from the first method (attenuating visible wavelengths below those of the red wavelengths associated with blood-red colors) produces a spectrum with a minimally attenuated blood-red color region 901 with amplitude 904 denoted with dotted-line “A”; and a more highly attenuated region with amplitude 905 denoted with dotted-line “B”.

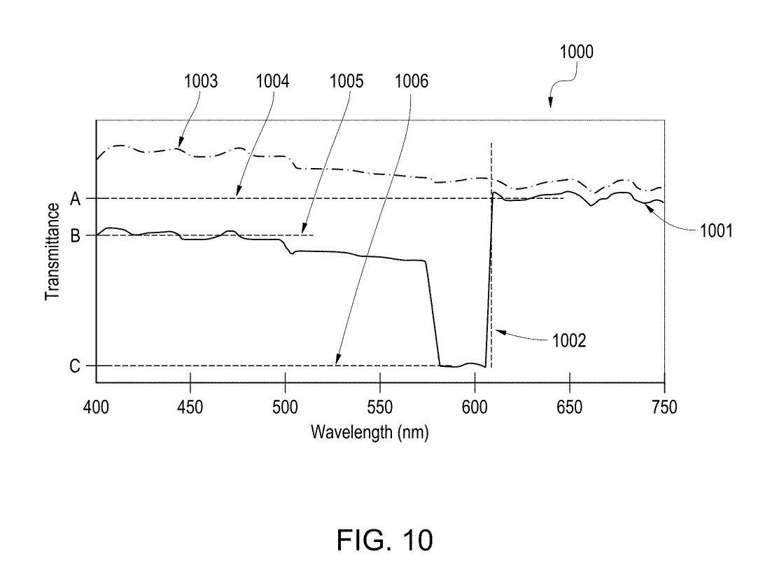

A second method is illustrated in FIG. 10, and includes the attenuations described by the first method. This second method includes additional and significant attenuation for red color wavelengths below those associated with blood-red colors. Wavelengths below the critical wavelength 1002 with a range that would likely stop at or near 590 nm; but could continue to a lower wavelength (e.g. 575 nm). Significant attenuation meaning that the filter has an optical density for these wavelengths that in some cases is greater than or equal to five (OD 5), but can be lower. Optical density and absorbance are synonymous. Optical density can be calculated from transmittance with the following equation:

Optical Density=2−LOG Base 10(% Transmittance)

And percentage transmittance can be calculated from optical density using the following equation:

% Transmittance=10\hat{ }(2−Optical Density)

Optical density is computed on a logarithmic scale which allows a small number like “OD 5” to represent the fact that only one 1000^{th} of one percent of light is transmitted thru the filter. Transmittance is useful when describing integer percentages (e.g. 80 percent) of light to be transmitted thru a filter; but optical density is used when extremely low percentages of transmittance are discussed. FIG. 10 shows how sunlight 1003 can be filtered and produce a blood-red filtered area 1001 receiving minimal attenuation to a level “A” 1004; and include a green and blue filtered area that receives more attenuation to a level “B” 1005; and a red (but not blood-red) filtered area that receives extreme (e.g. OD 5) attenuation to a level “C” 1006.

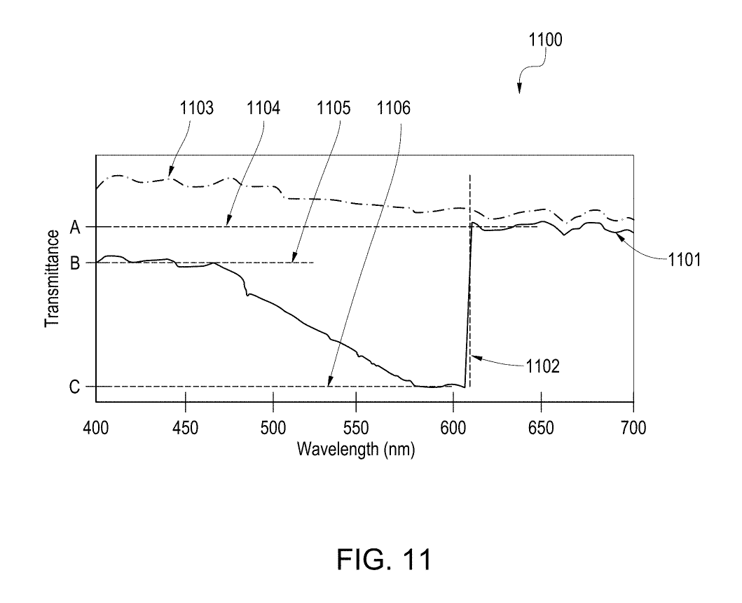

A third method is illustrated in FIG. 11, and includes the attenuations described by the first and second methods. FIG. 11 shows the third method whereby the light starting with wavelengths around 450 nm is progressively and increasingly attenuated as they approach the wavelength that starts the “red but not blood-red” colors (e.g. around 580 nm). The application of these three methods results in an optimal filter that can be used to promote (enhance) blood-red colors. The resulting filter has features that mimic those of the transmittance of blood (high red content, less blue content than red, and less green content than blue). The resultant spectrum shown in FIG. 11 shows the sunlight 1103 once filtered has three distinct amplitudes 1104, 1105, and 1106 denoted by dotted lines “A”, “B”, and “C” respectively. The relative values of these three amplitudes are important. First, the amplitude 1104 represents the amount of attenuation of the blood-red colors. Attenuation in the red wavelength area 1101 is desired to be minimal in order to maximize the transmittance in this area. The amplitude 1106 represents the amount of attenuation for the “red but not blood-red” colors. The amplitude 1105 represents the attenuation of the non-red colors; and these colors are progressively and increasingly attenuated moving from lower wavelength to higher wavelength. The relationship between the amplitudes 1104 and 1105 is important as it determines the relative amounts of red and non red filtering. It has been determined that the ratio of 1104 to 1105 be nearly equal to 2:1; but in some cases can be lower for example 4:3. That is to say that if the amplitude 1104 is 80% transmittance then the amplitude 1105 should be about 40%. And the amplitude 1106 should be extremely low (e.g. OD 5). Filters designed to aid in nighttime blood-trailing applications can require a much higher ratio for the blood-red wavelenths and non red wavelengths in order to compensate for the differences in the light spectrums (artificial versus sunlight) and for the differences in the response of human vision (photopic, mesopic, scotopic) between daytime and nighttime environments.

The filter may provide progressive attenuation of visible light wavelengths up to a blood-red color wavelength. In one example the filter passes wavelengths for blue and green but provides increasing attenuation thru yellow and orange wavelength colors. In another example the attenuation of the blue 1105 wavelengths is twice the amplitude of the attenuation of green wavelengths. Particular importance is given to the relative amplitudes of the red 1104 and the blue 1105. Secondarily importance is given to the relative amplitudes of green, yellow, and orange wavelengths.

Light absorbing materials are used in the construction of the lens(es). Lenses can be constructed using a variety of materials such as glass and plastics. The lenses can incorporate light absorbing materials; and these materials can be incorporated externally such as coatings and films; and theses materials can be incorporated internally such as dyes, pigments, and rare earth minerals. These light absorbing materials generally provide either wide-band or narrow-band filtration.

Wide-band absorbers are typically inexpensive but do not offer the necessary performance by themselves. Companies like Rosco provide wide-band filters like their Roscolux™ that use special dyes to provide color filtration. Narrow-band absorbers are by comparison more expensive. Companies like Epolin use special dyes to provide narrow-band color filtration. These narrow-band absorbers can provide extremely sharp notch filtration where wide-band absorbers cannot. These narrow-band absorbers also provide filtration that do not in many cases extend into the red wavelength areas.

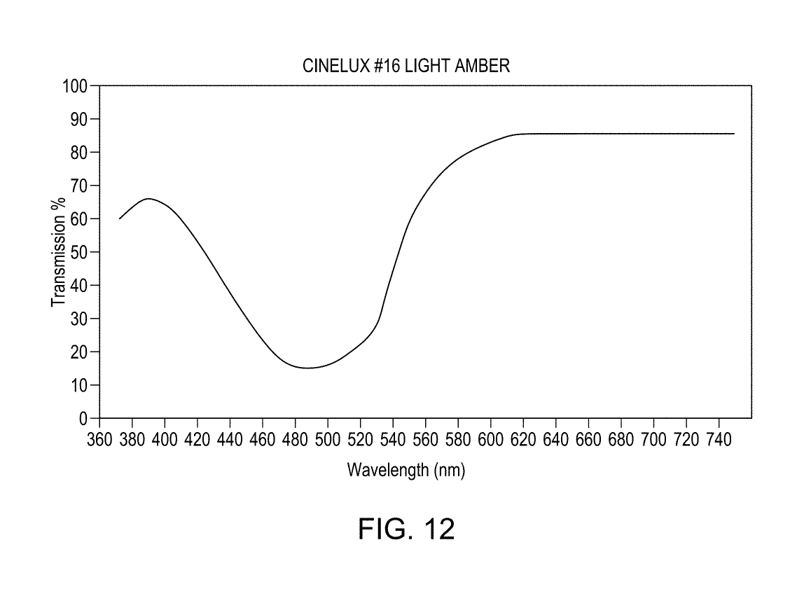

FIG. 12 shows the transmittance of a wide-band absorber (Cinelux #16 Light Amber). This type absorber is not able to provide sharp notches and is not able to provide significant optical densities as compared to narrow-band absorbers.

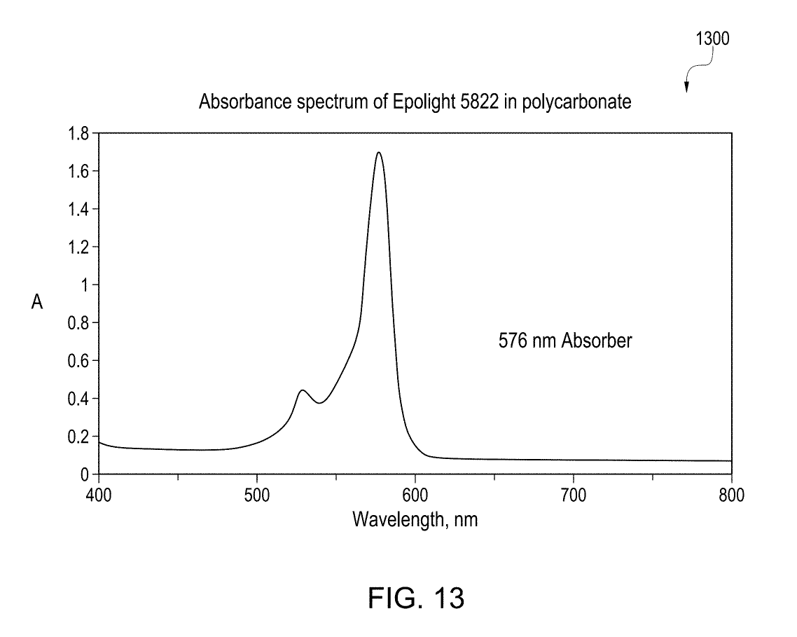

FIG. 13 shows the absorbance of a narrow-band absorber (Epolight 5822) with peak absorbance near 576 nm. This absorber is able to provide a sharp notch and keep the transmittance up around 80% in the red wavelength area.

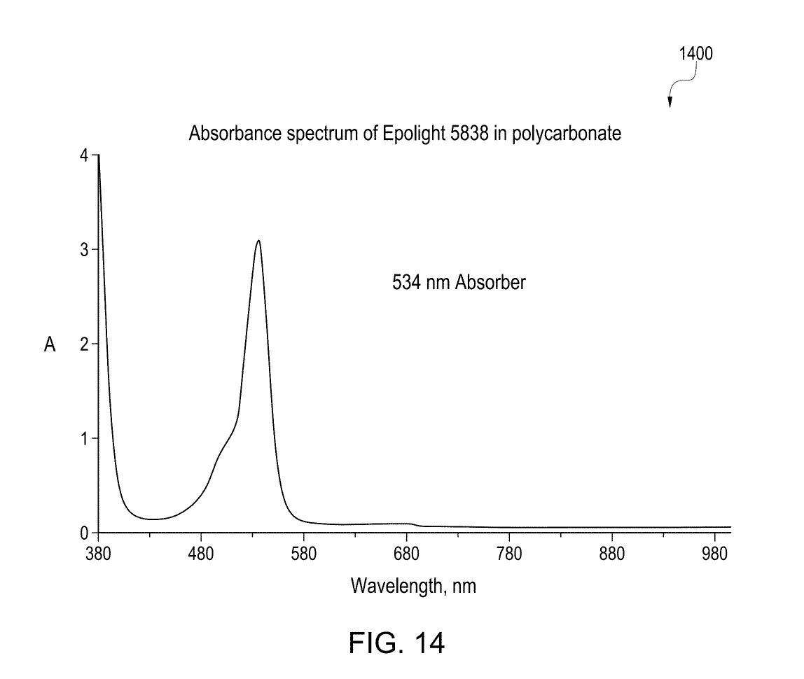

FIG. 14 shows the absorbance of a narrow-band absorber (Epolight 5838) with peak absorbance near 534 nm.

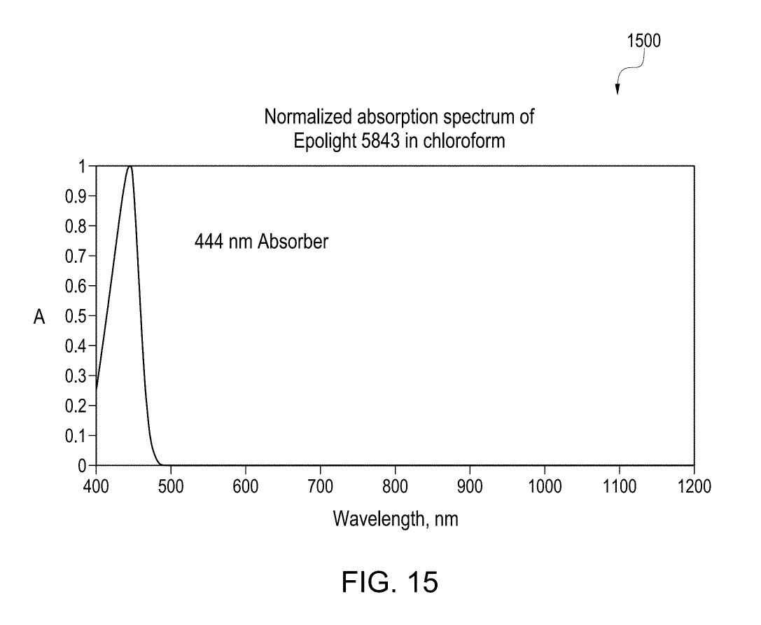

FIG. 15 shows the absorbance of a narrow-band absorber (Epolight 5843) with peak absorbance near 444 nm.

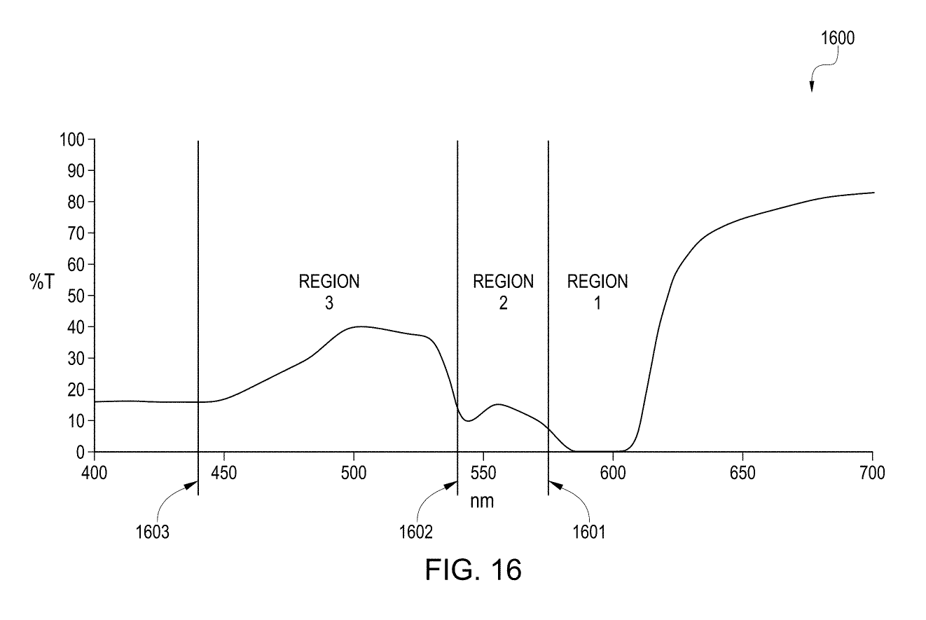

FIG. 16 shows the transmission percentage of light of exemplary eyewear as depicted in FIG. 1. FIG. 16 depicts the actual transmittance of a color-compounded lens produced using narrow-band absorbers in polycarbonate. This figure details three distinct regions (Region-1, Region-2, Region-3) separated by 1601, 1602, 1603 corresponding to wavelengths near 575 nm, 540 nm, and 440 nm respectively. Region-1 contains wavelengths that are predominately red, and the transmittance for these wavelengths are significantly higher than those of the wavelengths in the other two regions. Region-3 contains wavelengths that are predominately blue with some green (blue-green) and the peak amplitude of the hump in this region is significantly less than the peak amplitude of Region-1, Region-2 contains wavelengths that are predominately green and the peak amplitude of the hump in this region is less than the peak amplitude of Region-3.

As described above and shown in the associated drawings, the present invention comprises a blood-trailing eyewear apparatus. While particular embodiments have been described, it will be understood, however, that any invention appertaining to the apparatus described is not limited thereto, since modifications may be made by those skilled in the art, particularly in light of the foregoing teachings. It is, therefore, contemplated by the appended claims to cover any such modifications that incorporate those features or those improvements that embody the spirit and scope of the invention.

What I claim is:

1. Eyewear for hunting, comprising:
a lens; and
a filter incorporated into the lens configured for transmitting blood-red colors.

2. The eyewear of claim 1, wherein the blood-red colors comprise a predominantly red transmittance region, a green transmittance region that is significantly less than the red transmittance region, and a blue-green transmittance region that is less than the red transmittance region but more than the green transmittance region.

3. The eyewear of claim 2, wherein the filter is configured to transmit the predominantly red transmittance region, the green transmittance region, and the blue-green transmittance region.

4. The eyewear of claim 3, wherein narrow-band absorbers are located between the red transmittance region and the green transmittance region and between the green transmittance region and the blue-green transmittance region.

5. The eyewear of claim 1, wherein the filter is configured to operate with the photopic response of the eye.

6. The eyewear of claim 1, wherein the filter is configured to attenuate all colors that are not blood-red colors.

7. The eyewear of claim 1, wherein the filter is configured to significantly attenuate red colors that have wavelengths below those of blood-red colors.

8. The eyewear of claim 1, where the filter is configured to progressively attenuate other specific non red colors with emphasis put on the relative attenuations across the progression.

9. The eyewear of claim 1, wherein the filter is configured to transition from maximum attenuation to minimum attenuation at a transition wavelength.

10. The eyewear of claim 9, wherein the transition wavelength is in the range of about 580 nanometers (nm) to 620 nm.

11. The eyewear of claim 1, wherein the filter is comprised of a pigment or dye incorporated into the material of the lens.

12. The eyewear of claim 1, wherein the filter is a coating or a film applied to the lens.

13. The eyewear of claim 1, wherein the filter is comprised of rare earth minerals.

14. The eyewear of claim 1, wherein the blood-red colors are at or above 580 nanometers.

15. Eyewear for hunting, comprising:
a lens;
a filter applied to the lens configured to attenuate all colors that are not blood-red colors, significantly attenuate red colors that have wavelengths below blood-red colors, and progressively attenuate other non red colors with emphasis put on the relative attenuations across the progression so that a hunter can follow a blood trail during daylight.

16. The eyewear of claim 15, wherein the blood-red colors comprise a predominantly red transmittance region, a green transmittance region that is significantly less than the red transmittance region, and a blue-green transmittance region that is less than the red transmittance region but more than the green transmittance region.

17. The eyewear of claim 15, wherein the filter is comprised of a pigment or dye incorporated into the material of the lens.

18. The eyewear of claim 15, wherein the filter is a coating or a film applied to the lens.

19. The eyewear of claim 15, wherein the filter is comprised of rare earth minerals.

20. The eyewear of claim 15, wherein the blood-red colors are at or above 580 nanometers.
